(19) United States
(12) Patent Application Publication
(10) Pub. No.: US 2025/0126539 A1
(43) Pub. Date: Apr. 17, 2025

(54) METHODS AND APPARATUSES FOR COMBINED CONDITION IN CHO PROCEDURE

(71) Applicant: LENOVO (BEIJING) LIMITED, Beijing (CN)

(72) Inventors: Lianhai WU, Beijing (CN); Mingzeng DAI, Shanghai (CN); Le YAN, Shanghai (CN); Congchi ZHANG, Shanghai (CN)

(21) Appl. No.: 18/684,503

(22) PCT Filed: Aug. 18, 2021
(86) PCT No.: PCT/CN2021/113252

§ 371 Date: Feb. 16, 2024

(51) Int. Cl. H04W 36/36; H04W 36/00; H04W 36/30

(52) U.S. Cl. CPC H04W 36/362; H04W 36/0079; H04W 36/305

(57) ABSTRACT

Embodiments of the present application relate to methods and apparatuses for a combined condition in a conditional handover (CHO) procedure under a 3rd Generation Partnership Project (3GPP) 5G system or the like. According to an embodiment of the present application, a method can be performed by a user equipment (UE) and can include: receiving, from a network node, CHO configuration information associated with a candidate cell of the UE, wherein the CHO configuration information includes an execution condition comprising an event and a further event; and transmitting, to the network node, assistant information related to at least one of the event and the further event.

### TECHNICAL FIELD

Embodiments of the present application generally relate to wireless communication technology, in particular to methods and apparatuses for a combined condition in a conditional handover (CHO) procedure.

### BACKGROUND

A base station (BS) can have some cells (or areas) to provide communication service. When a user equipment (UE) moves from a serving cell of a source BS to a target cell of a target BS, a handover procedure is performed. When a radio link failure (RLF) or a handover (HO) failure occurs for a UE, the UE may perform a radio resource control (RRC) re-establishment procedure. The UE may access a cell by a successful RRC re-establishment procedure. The accessed network will request UE information including a RLF report of the UE, such that the network can optimize the mobility problem based on the UE information from the UE. Accordingly, the UE will transmit a failure report to the network.

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. Details regarding how to fulfill a combined condition in a CHO procedure have not been discussed in 3GPP 5G technology yet.

### SUMMARY

Some embodiments of the present application provide a method, which may be performed by a UE. The method includes: receiving, from a network node, CHO configuration information associated with a candidate cell of the UE, wherein the CHO configuration information includes an execution condition comprising an event and a further event; and transmitting, to the network node, assistant information related to at least one of the event and the further event.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a UE. The UE includes a processor and a wireless transceiver coupled to the processor; and the processor is configured: to receive, via the wireless transceiver from a network node, CHO configuration information associated with a candidate cell of the UE, wherein the CHO configuration information includes an execution condition comprising an event and a further event; and to transmit, via the wireless transceiver to the network node, assistant information related to at least one of the event and the further event.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of an intra-AMF/UPF CHO procedure in accordance with some embodiments of the present application;

FIG. 3 illustrates an exemplary UE information procedure in accordance with some embodiments of the present application;

FIG. 4 illustrates an exemplary failure indication procedure in accordance with some embodiments of the present application;

FIG. 5 illustrates an exemplary flow chart of transmitting assistant information of an event in a CHO procedure in accordance with some embodiments of the present application;

FIG. 6 illustrates an exemplary table of fulfillments of two events in a CHO procedure in accordance with some embodiments of the present application;

FIG. 7 illustrates a further exemplary table of fulfillments of two events in a CHO procedure in accordance with some embodiments of the present application;

FIG. 8 illustrates another exemplary table of fulfillments of two events in a CHO procedure in accordance with some embodiments of the present application; and

FIG. 9 illustrates an exemplary block diagram of an apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

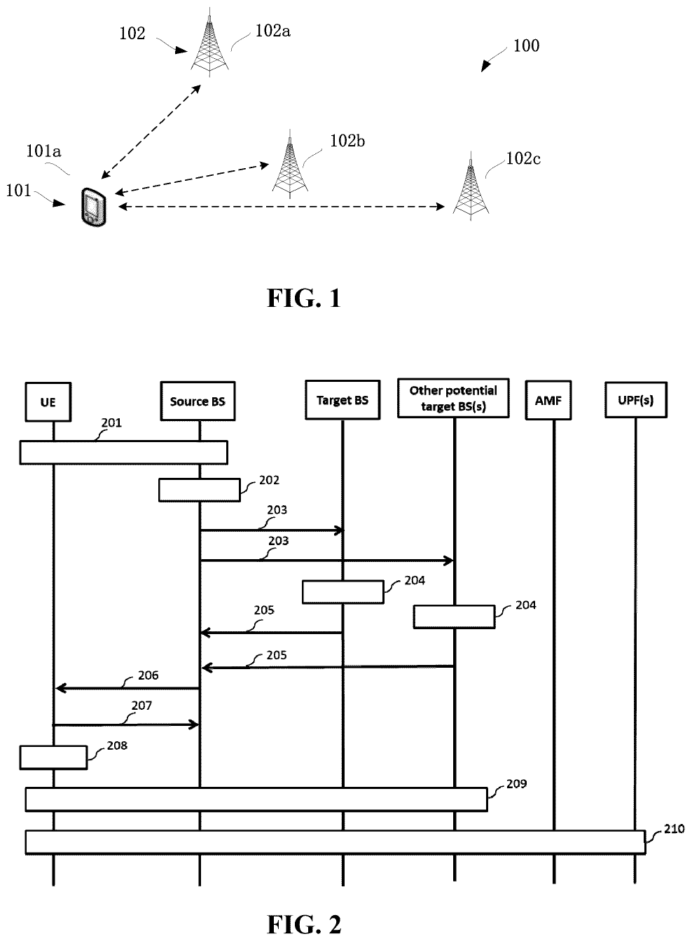

FIG. 1 illustrates a schematic diagram of a wireless communication system in accordance with some embodiments of the present application.

As illustrated and shown in FIG. 1, a wireless communication system 100 includes at least one UE 101 and at least one BS 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may perform a cell section procedure between different cell(s) of different BS(s). Each UE(s) 101 may handover from a serving cell of a source BS to a target cell of a target BS. For example, in the wireless communication system 100 as illustrated and shown in FIG. 1, BS 102a may function as a source BS, and each of BS 102b and BS 102c may function as a target BS. If there is a handover need, UE 101a as illustrated and shown in FIG. 1 may perform a handover procedure from a serving cell of BS 102a to a target cell of BS 102b or a target cell of BS 102c, which depends a result of a cell selection procedure. The handover procedure performed by UE 101a may be a CHO procedure.

As specified in 3GPP standard documents, CHO is defined as a handover that is executed by a UE when one or more handover execution conditions are met. The UE starts evaluating the execution condition(s) upon receiving the CHO configuration, and stops evaluating the execution condition(s) during the CHO procedure once the execution condition(s) is met.

FIG. 2 illustrates an exemplary flowchart of an intra-AMF/UPF CHO procedure in accordance with some embodiments of the present application. The embodiments of FIG. 2 depict a basic CHO scenario where neither an access and mobility management function (AMF) nor a user plane function (UPF) changes.

Referring to FIG. 2, in operation 201, a source BS (e.g., BS 102a as illustrated and shown in FIG. 1) may transmit measurement configuration information to a UE (e.g., UE 101a as illustrated and shown in FIG. 1), and the UE may report a measurement result to the source BS based on the measurement configuration information. In operation 202, the source BS may decide to use a CHO procedure of the UE, which is based on the measurement result reported by the UE.

In operation 203, the source BS may transmit CHO REQUEST message to one target BS (e.g., BS 102b as illustrated and shown in FIG. 1) and other potential target BS(s) (e.g., BS 102c as illustrated and shown in FIG. 1). In operation 204, the target BS or other potential target BS(s) may perform an admission control based on the load of a target cell of the target BS or other potential target BS(s), to decide whether to allow the CHO procedure of the UE after receiving the CHO REQUEST message from the source BS.

In operation 205, based on an admission control result, the target BS or other potential target BS(s) may prepare handover resource(s) for the UE and send CHO REQUEST ACKNOWLEDGE message to the source BS.

In operation 206, the source BS may transmit RRCReconfiguration message to the UE. The RRCReconfiguration message may include configuration information of CHO candidate cell(s) and the corresponding CHO execution condition(s).

In operation 207, the UE may transmit RRCReconfigurationComplete message to the source BS. In operation 208, the UE may evaluate the CHO condition(s). If one of the CHO candidate cells satisfies the CHO execution condition(s), the UE may detach from the source cell and synchronize to the CHO candidate cell which satisfies the CHO execution condition(s).

In operation 209, the UE may transmit a CHO completion message to the target BS or other potential target BS(s). In operation 210, the 5G network may switch the DL data path towards the target BS or other potential target BS(s). Any ongoing data forwarding may continue.

Generally, in a UE information procedure, after a RLF or a HO failure occurs, a UE may perform a RRC re-establishment procedure in a cell. The UE will store some information related with the RLF failure and/or the HO failure. The UE stores the latest RLF Report, including both LTE and NR RLF report until the RLF report is fetched by the network or for 48 hours after the connection failure is detected. For analysis of connection failure(s), the UE makes the RLF report available to the network.

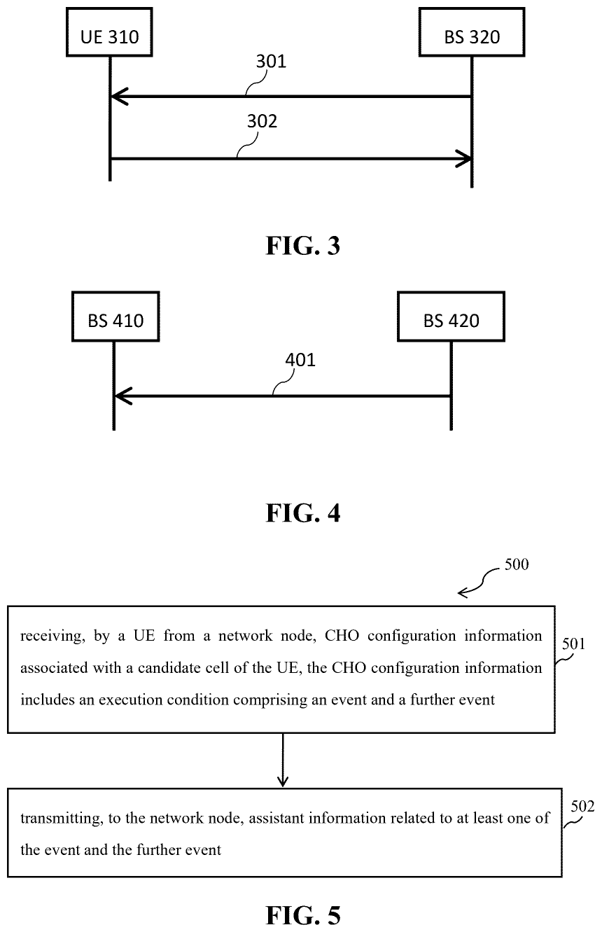

FIG. 3 illustrates an exemplary UE information procedure in accordance with some embodiments of the present application. The embodiments of FIG. 3 show a procedure of a UE (e.g., UE 310) communicating with a BS (e.g., BS 320). In some examples, UE 310 may function as UE 101a in FIG. 1. BS 320 may function as BS 102a, BS 102b, or BS 102c in FIG. 1.

As shown in FIG. 3, in operation 301, BS 320 (e.g., BS 102a as illustrated and shown in FIG. 1) transmits UE Information Request message to UE 310 (e.g., UE 101a as illustrated and shown in FIG. 1). BS 320 may be a source BS which controls a serving cell of UE 310. In operation 302, US 310 transmits UE Information Response message including a RLF report to BS 320. BS 320 can optimize a mobility problem based on the response transmitted from UE 310.

In a 3GPP 5G system, a failure indication may be initiated after a UE attempts to re-establish the radio link connection at NG-RAN node B (e.g., BS 420 in FIG. 4) after a failure at NG-RAN node A (e.g., BS 410 in FIG. 4). NG-RAN node B (e.g., BS 420 in FIG. 4) may initiate a failure indication procedure towards multiple NG-RAN nodes if they control cells which use a physical cell identifier (PCI) signaled by the UE during the RRC re-establishment procedure. A failure indication may also be sent to the node last serving the UE when the NG-RAN node fetches the RLF report from the UE. A specific example of a failure indication procedure is described in FIG. 4.

The purpose of the failure indication procedure is to transfer information regarding RRC re-establishment attempts, or received RLF reports, between NG-RAN nodes. The signaling takes place from the NG-RAN node at which a re-establishment attempt is made, or a RLF report is received, to an NG-RAN node to which the UE concerned may have previously been attached prior to the connection failure. This may aid the detection of a RLF case or a HO failure case.

FIG. 4 illustrates an exemplary failure indication procedure in accordance with some embodiments of the present application. The embodiments of FIG. 4 show a procedure of one BS (e.g., BS 410) communicating with another BS (e.g., BS 420). In some examples, BS 410 or BS 420 may function as BS 102a, BS 102b, or BS 102c in FIG. 1.

As shown in FIG. 4, in operation 401, BS 420 transmits a failure indication message to BS 410. BS 410 is a source BS which controls the original serving cell of a UE (e.g., UE 101a as illustrated and shown in FIG. 1). BS 420 is a target BS or a new BS which controls a target cell or a CHO candidate cell of the UE. The failure indication message may be transmitted by Xn interface or X2 interface. For example, the failure indication message includes a container of a RLF report. The container of the RLF report may be transmitted by Xn interface or X2 interface.

According to agreements of 3GPP RAN2, in a CHO procedure, a CHO command may also be named as CHO configuration information. The CHO configuration information may contain: (1) configuration of CHO candidate cell(s) generated by candidate BS(s); and (2) execution condition(s) for the CHO candidate cell(s) generated by a source BS. Currently, following issues need to be solved: (a) in a case that a CHO procedure with a combined condition is not triggered, because parameter(s) of a combined condition of the CHO procedure are not suitable, how to adjust the unsuitable combined condition of the CHO procedure; and (b) in a case that a CHO procedure with a combined condition is triggered, but some ‘dangerous’ situation, e.g., a leaving condition is met when the CHO procedure is triggered should be addressed, how to optimize the unsuitable combined condition in the successful CHO procedure.

Embodiments of the present application aim to solve the above issues. Some embodiments of the present application provide solutions in which assistant information is reported by a UE to a network node for an optimization purpose. Different assistant information is proposed based on different use cases. More details will be illustrated in the following text in combination with the appended drawings.

FIG. 5 illustrates an exemplary flow chart of transmitting assistant information of an event in a CHO procedure in accordance with some embodiments of the present application. The method 500 may be performed by a UE (e.g., UE 101, the UE, or UE 310 as shown and illustrated in any of FIGS. 1-3). Although described with respect to a UE, it should be understood that other devices may also be configured to perform the method as shown and illustrated in FIG. 5.

In the exemplary method 500 as shown in FIG. 5, in operation 501, a UE (e.g., UE 101 as shown and illustrated in FIG. 1) receives, from a network node, CHO configuration information associated with a candidate cell of the UE. The CHO configuration information includes an execution condition comprising an event and a further event. In operation 502, the UE transmits, to the network node, assistant information related to at least one of the event and the further event. In following text, the event is named as “the 1st event”, and the further event is named as “the 2nd event”.

In some embodiments, each of the 1st event and the 2nd event may be Event A3, Event A4, or Event A5 as defined in 3GPP standard document TS38.331. In an example, the execution condition comprises Event A3 and Event A4. In a further example, the execution condition comprises Event A3 and Event A5. In another example, the execution condition comprises Event A3 and Event A3. In an additional example, the execution condition comprises Event A4 and Event A4. In an additional example, the execution condition comprises Event A4 and Event A5. In an additional example, the execution condition comprises Event A5 and Event A5.

According to some embodiments, in response to a presence of a RLF or a handover failure, the UE performs a RRC re-establishment procedure to a cell. In an embodiment, the UE transmits, to the re-established cell, an indication of an available state of the assistant information. The UE may receive a UE information request message from the re-established cell. Then, the UE may transmit, to the re-established cell, a UE information response message including the assistant information.

In some embodiments, the assistant information includes at least one of:
(1) a measurement result of a serving cell of the UE if the 1st event is considered by the UE to be ‘fulfilled’;
(2) a measurement result of the candidate cell of the UE if the 1st event is considered by the UE to be ‘fulfilled’;
(3) the measurement result of the serving cell if the 2nd event is considered by the UE to be ‘fulfilled’; and
(4) the measurement result of the candidate cell if the 2nd event is considered by the UE to be ‘fulfilled’.

In some other embodiments, the assistant information includes at least one of:
(1) a measurement result of a serving cell of the UE if the 1st event is considered by the UE to be ‘not fulfilled’;
(2) a measurement result of the candidate cell if the 1st event is considered by the UE to be ‘not fulfilled’;
(3) the measurement result of the serving cell if the 2nd event is considered by the UE to be ‘not fulfilled’; and
(4) the measurement result of the candidate cell if the 2nd event is considered by the UE to be ‘not fulfilled’.

According to some embodiments, if the 1st event is considered by the UE to be fulfilled, the UE transmits, to the network node, information indicating that the 1st event is in a fulfilled state; and the UE transmits information associated with the 1st event to the network node. For instance, the information associated with the 1st event includes at least one of:
(1) information regarding a timer to trigger (TTT);
(2) a measurement object specific offset of a reference signal of a neighbor cell of the UE, e.g., Ofn as defined in 3GPP TS38.331;
(3) a cell specific offset of the neighbor cell of the UE, e.g., Ocn as defined in 3GPP TS38.331;
(4) a measurement object specific offset of a primary cell of a master or secondary cell group (SpCell) of the UE, e.g., Ofp as defined in 3GPP TS38.331;
(5) a cell specific offset of the SpCell of the UE, e.g., Ocp as defined in 3GPP TS38.331; and
(6) an offset parameter for the 1st event, e.g., Off as defined in 3GPP TS38.331.

In some embodiments, the assistant information includes at least one of:
(1) an entry condition of the 2nd event is ‘met’ if the 1st event is considered by the UE to be ‘fulfilled’; and
(2) the entry condition of the 2nd event is ‘not met’ if the 1st event is considered by the UE to be ‘fulfilled’.

In some other embodiments, the assistant information includes at least one of:
(1) a maximum time period of meeting an entry condition of the 2nd event while the 1st event is in a ‘fulfilled’ state; and
(2) a maximum time period of meeting an entry condition of the 1st event while the 2nd event is in a ‘fulfilled’ state.

In yet some other embodiments, the assistant information includes at least one of:
(1) absolute time when the 1st event is considered by the UE to be ‘fulfilled’;
(2) absolute time when the 1st event is considered by the UE to be ‘not fulfilled’;
(3) absolute time when the 2nd event is considered by the UE to be ‘fulfilled’; and
(4) absolute time when the 2nd event is considered by the UE to be ‘not fulfilled’.

In yet some other embodiments, the assistant information includes at least one of:
(1) a time duration since “the 1st event considered to be fulfilled” until “the 1st event considered to be not fulfilled”;
(2) a time duration since “the 1st event considered to be fulfilled” until “the 2nd event considered to be fulfilled”; and
(3) a time duration since “the 1st event considered to be not fulfilled” until “the 2nd event considered to be fulfilled”.

According to some embodiments, the UE performs a CHO procedure in response to meeting the execution condition, and the UE transmits a successful handover report (SHR) in response to meeting a trigger condition.

In some embodiments, the trigger condition is at least one of:
(1) a leaving condition of the 1st event is ‘met’ when the UE triggers to perform the CHO procedure; and
(2) a leaving condition of the 2nd event is ‘met’ when the UE triggers to perform the CHO procedure.

In some other embodiments, the trigger condition is at least one of:
(1) a time duration since “the 1st event considered to be fulfilled” until “the 2nd event considered to be fulfilled” is greater than or equal to a threshold; and
(2) a time duration since “the 2nd event considered to be fulfilled” until “the 1st event considered to be fulfilled” is greater than or equal to another threshold.

In some embodiments, the SHR includes at least one of:
(1) a time duration of consecutively meeting a leaving condition of the 1st event when the UE performs the CHO procedure;
(2) a time duration of consecutively meeting a leaving condition of the 2nd event when the UE performs the CHO procedure;
(3) a time duration since “the 1st event considered to be fulfilled” until “the 2nd event considered to be fulfilled”;
(4) a time duration since “the 1st event is considered to be fulfilled” until “the 1st event is considered to be not fulfilled”;
(5) the absolute time when the 1st event is considered to be ‘fulfilled’;
(6) the absolute time when the 1st event is considered to be ‘not fulfilled’;
(7) the absolute time when the 2nd event is considered to be ‘fulfilled’;
(8) the absolute time when the 2nd event is considered to be ‘not fulfilled’; and
(9) a time duration since “the 1st event is considered to be not fulfilled” until “the 2nd event is considered to be fulfilled”.

Details described in all other embodiments of the present application (for example, details of how to fulfill a combined condition in a CHO procedure) are applicable for the embodiments of FIG. 5. Moreover, details described in the embodiments of FIG. 5 are applicable for all the embodiments of FIGS. 1-4 and 6-9.

The following texts describe specific Embodiments 1-3 of the method as shown and illustrated in FIG. 5. According to Embodiments 1-3, a UE, a source BS, and a target BS perform the following operations. The UE may be UE 101, the UE, or UE 310 as shown and illustrated in any of FIGS. 1-3. The source BS or the target BS may be BS 102a, BS 102b, BS 102c, a source BS, a target BS, BS 320, BS 410, or BS 420 as illustrated and shown in any of FIGS. 1-4.

### Embodiment 1

(1) Step 1: A UE is in a RRC_Connected state. A source BS configures the UE to report a measurement result.
   The UE will report the measurement result based on the configuration information received from the source BS.
(2) Step 2: The UE is configured with CHO configuration information associated with CHO candidate cell(s) based on the measurement result.
   The CHO configuration information contains: (1) configuration information of CHO candidate cell(s) generated by candidate BS(s); and (2) execution condition(s) generated by the source BS. For example, CHO configuration information for a CHO candidate cell (e.g., CHO candidate cell #1) is configured to the UE. In one example, the corresponding execution condition is the combined condition of Event A3 and Event A5 as defined in 3GPP TS38.331.
(3) Step 3: The UE begins to evaluate the CHO execution condition when the UE receives the CHO configuration information.
(4) Step 4: The UE considers the 1st event (e.g., Event A3, Event A4, or Event A5) to be ‘fulfilled’.
   Another event, i.e., the 2nd event, (e.g., Event A3, Event A4, or Event A5) is in a ‘not fulfilled’ state.
   The UE stores following information:
      (1) A measurement result of the corresponding serving cell and the candidate cell of the UE when the 1st event is considered to be ‘fulfilled’.
      (2) Time duration between “the 1st event is considered to be fulfilled” and “the 1st event is considered to be not fulfilled”.
      (3) The absolute time when the 1st event is considered to be ‘fulfilled’; and/or the absolute time when the 1st event is considered to be ‘not fulfilled’.
(5) Step 5 (optional): The UE considers the 1st event (e.g., Event A3, Event A4, or Event A5) to be ‘not fulfilled’ (e.g., a leaving condition of Event A3 is met during a TTT).
   The 2nd event (e.g., Event A3, Event A4, or Event A5) is in a ‘not fulfilled’ state.
   The UE stores following information:
      (1) A measurement result of the corresponding serving cell and the candidate cell associated with the 2nd event when the 1st event is considered to be ‘not fulfilled’.
      (2) Time duration between “the 1st event is considered to be fulfilled” and “the 1st event is considered to be not fulfilled”.
      (3) The absolute time when the 1st event is considered to be fulfilled; and/or the absolute time when the 1st event is considered to be not fulfilled.
(6) Step 6: The UE declares a RLF.
(7) Step 7: The UE initiates a RRC re-establishment procedure and performs a cell selection procedure.
(8) Step 8: The UE transmits RRC Reestalishment Request message to the selected suitable cell. After successfully re-establishing to one suitable cell, the UE transmits an indication, which indicates an available state of assistant information, to the serving cell. The assistant information is associated with a failure report.
(9) Step 9: A target BS (e.g., a target gNB) transmits UE Information Request message to the UE after receiving the indication from the UE.
(10) Step 10: The UE transmits UE Information Response message to the target BS. Following information may be included in the UE Information Response message.
   a) The 1st event (e.g., Event A3, Event A4, or Event A5) is considered to be ‘fulfilled’. After a period of a ‘fulfilled’ state, the 1st event (e.g., Event A3, Event A4, or Event A5) is considered to be ‘not fulfilled’. And the 2nd event is not considered by the UE to be ‘fulfilled’.
   b) In some cases, an event (e.g., the 1st event) may be considered to be ‘fulfilled’ more than one time, e.g., at different time units in time domain.
   c) The UE reports measurement result(s) when one event is considered to be ‘fulfilled’ or ‘not fulfilled’. For example, the UE may report:
      (1) The measurement result of the corresponding serving cell and the candidate cell associated with the 2nd event when the 1st event is considered to be ‘fulfilled’.
      (2) The measurement result of the corresponding serving cell and the candidate cell associated with the 2nd event when the 1st event is considered to be ‘not fulfilled’.
   d) The UE indicates which event is considered to be ‘fulfilled’.
      (1) The UE reports the 1st event that the 1st event is considered to be fulfilled.
         For instance, the UE may report Event A3, Event A4, or Event A5 and corresponding parameter(s) of Event A3, Event A4, or Event A5 (e.g., a TTT).
   e) The UE report the status for the 2nd event when the 1st event is considered to be ‘fulfilled’. The status of the 2nd event could be as follow:
      (1) The entry condition of the 2nd event is ‘met’ when the 1st event is considered to be ‘fulfilled’.
      (2) The entry condition of the 2nd event is ‘not met’ when the 1st event is considered to be ‘fulfilled’.
      (3) The UE indicates a maximum period of meeting the entry condition of the 2nd event while the 1st event is considered to be ‘fulfilled’.
   f) Time information can be reported to optimize combined condition configuration of event(s) in a CHO procedure.
      (1) Time duration between “the 1st event is considered to be fulfilled” and “the 1st event is considered to be not fulfilled”.
      (2) The absolute time when the 1st event is considered to be ‘fulfilled’; and/or the absolute time when the 1st event is considered to be ‘not fulfilled’.
(11) Step 11: After the target BS receives the report message from UE, the target base station will transmit one Xn message (e.g., a failure indication message or a new Xn message) to the source BS.
   The report message reported by the UE may be transmitted as a container.

### Embodiment 2

(1) Step 1: A UE is in a RRC_Connected state. A source BS configures the UE to report a measurement result.
   The UE will report the measurement result based on the configuration information received from the source BS.
(2) Step 2: The UE is configured with CHO configuration information associated with CHO candidate cell(s) based on the measurement result.
   The CHO configuration information contains: (1) configuration information of CHO candidate cell(s) generated by candidate BS(s); and (2) execution condition(s) generated by the source BS. For example, CHO configuration information for a CHO candidate cell (e.g., CHO candidate cell #1) is configured to the UE. In one example, the corresponding execution condition is the combined condition of Event A3 and Event A5 as defined in 3GPP TS38.331.
(3) Step 3: The UE begins to evaluate the CHO execution condition when the UE receives the CHO configuration information.
(4) Step 4: The UE considers the 1st event (e.g., Event A3, Event A4, or Event A5) to be fulfilled.
   Another event, i.e., the 2nd event (e.g., Event A3, Event A4, or Event A5), is in a ‘not fulfilled’ state.
   The UE stores following information:
      (1) A measurement result of the corresponding serving cell and the candidate cell when the 1st event is considered to be ‘fulfilled’.
      (2) Time duration between “the 1st event is considered to be fulfilled” and “the 1st event is considered to be not fulfilled”.
      (3) The absolute time when the 1st event is considered to be ‘fulfilled’; and/or the absolute time when the 1st event is considered to be ‘not fulfilled’.
(5) Step 5 (optional): The UE considers the 1st event (e.g., Event A3) to be ‘not fulfilled’ (e.g., a leaving condition of Event A3 is met during a TTT).
   The 2nd event (e.g., Event A3, Event A4, or Event A5) is in a ‘not fulfilled’ state.
   The UE stores following information:
      (1) The measurement result of the corresponding serving cell and candidate cell associated with the 2nd event when the 1st event is considered to be ‘not fulfilled’.
      (2) Time duration between “the 1st event is considered to be fulfilled” and “the 1st event is considered to be not fulfilled”.
      (3) The absolute time when the 1st event is considered to be ‘fulfilled’; and/or the absolute time when the 1st event is considered to be ‘not fulfilled’.
(6) Step 6: The UE considers the 2nd event (e.g., Event A5) to be ‘fulfilled’ (after the UE considers the 1st event (e.g., Event A3) to be ‘not fulfilled’).
   The UE stores that the 2nd event is considered to be ‘fulfilled’
   The UE stores the measurement result of the corresponding serving cell and the candidate cell when the 2nd event is considered to be ‘fulfilled’ (or ‘not fulfilled’).
   The UE stores the absolute time when the 2nd event is considered to be ‘fulfilled’; and/or the absolute time when the 2nd event is considered to be ‘not fulfilled’, e.g., universal time coordinated (UTC) time.
(7) Step 7: The UE declares a RLF. Or, the UE receives a handover command, but a handover failure happens (e.g., timer T304 expiry)
(8) Step 8: The UE initiates a RRC re-establishment procedure and performs a cell selection procedure.
(9) Step 9: The UE transmits RRC Reestalishment Request message to the selected suitable cell. After successfully re-establishing to one suitable cell, the UE transmits an indication of an available state of assistant information to the serving cell. The assistant information is associated with a failure report.
(10) Step 10: A target BS (e.g., a target gNB) transmits UE Information Request message to the UE after receiving the indication from the UE.
(11) Step 11: The UE transmits UE information response message to the target BS. Following information may be included in the UE information response message:
   a) The 1st event (e.g., Event A3) is considered to be ‘fulfilled’. Then, the 1st event (e.g., Event A3) is considered to be ‘not fulfilled’. The 2nd event is considered by the UE to be fulfilled after the 1st event is considered to be ‘not fulfilled’.
   b) The UE reports measurement result(s) when one condition is considered to be ‘fulfilled’ or ‘not fulfilled’.
      (1) The measurement result of the corresponding serving cell and the candidate cell associated with the 2nd event when the 1st event is considered to be ‘fulfilled’.
      (2) The measurement result of the corresponding serving cell and the candidate cell when the 1st event is considered to be ‘not fulfilled’.
      (3) The measurement result of the corresponding serving cell and the candidate cell when the 2nd event is considered to be ‘fulfilled’ (or ‘not fulfilled’).
   c) The UE indicates which event is considered to be ‘fulfilled’.
      (1) UE reports the 1st event that the 1st event is considered to be ‘fulfilled’.
         For instance, the UE may report Event A3, Event A4, or Event A5 and the corresponding parameter(s) of Event A3, Event A4, or Event A5 (e.g., a TTT).
   d) The UE report a status for the 2nd event when the 1st event is considered to be ‘fulfilled’. The status of the 2nd event could be as follow.
      (1) The entry condition of the 2nd event is ‘met’ when the 1st event is considered to be ‘fulfilled’.
      (2) The entry condition of the 2nd event is ‘not met’ when the 1st event is considered to be ‘fulfilled’.
      (3) The UE indicates a maximum period of meeting entry condition of the 2nd event while the 1st event is considered to be ‘fulfilled’.
      (4) The UE indicates a maximum period of meeting entry condition of the 1st event while the 2nd event is considered to be ‘fulfilled’.
   e) Time information can be reported to optimize combined condition configuration of event(s) in a CHO procedure.
      (1) Time duration between “the 1st event is considered to be fulfilled” and “the 1st event is considered to be not fulfilled”.
      (2) The absolute time when the 1st event is considered to be ‘fulfilled’; and/or the absolute time when the 1st event is considered to be ‘not fulfilled’.
      (3) The absolute time when the 2nd event is considered to be ‘fulfilled’; and/or the absolute time when the 2nd event is considered to be ‘not fulfilled’, e.g., UTC time.
      (4) Time duration between “the 1st event is considered to be fulfilled” and “the 2nd event is considered to be fulfilled”.
      (5) Time duration between “the 1st event is considered to be not fulfilled” and “the 2nd event is considered to be fulfilled”.
(12) Step 12: After the target BS receives the UE information response message from the UE, the target BS will transmit one Xn message (e.g., a failure indication message or a new Xn message) to the source BS.

### Embodiment 3

(1) Step 1: A UE is in a RRC_Connected state. A source BS configures the UE to report a measurement result.
   The UE will report the measurement result based on the configuration information received from the source BS.
(2) Step 2: The UE is configured with CHO configuration information associated with CHO candidate cell(s) based on the measurement result.
   The CHO configuration information contains: (1) configuration information of CHO candidate cell(s) generated by candidate BS(s); and (2) execution condition(s) generated by the source BS. For example, CHO configuration information for a CHO candidate cell (e.g., CHO candidate cell #1) is configured to the UE. In one example, the corresponding execution condition is a combined condition of Event A3 and Event A5 as defined in 3GPP TS38.331.
(3) Step 3: The UE begins to evaluate the CHO execution condition when the UE receives the CHO configuration information.
(4) Step 4: The UE considers the 1st event (e.g., Event A3) to be ‘fulfilled’.
(5) Step 5: The UE considers the 2nd event (e.g., Event A5) to be ‘fulfilled’.
   The 1st event (e.g., Event A3) is still in a ‘fulfilled’ state.
   The SHR will be triggered if one of the following conditions are fulfilled:
      (1) Leaving condition of an event (e.g., Event A3 or Event A5) is ‘met’ when the CHO procedure is triggered.
      (2) Time duration between “the 1st event is considered to be fulfilled” and “the 2nd event is considered to be fulfilled” is greater than or equal to one configured threshold.
(6) Step 6: The UE performs the CHO procedure when both the 1st event (e.g., Event A3) and the 2nd event (e.g., Event A5) are in a ‘fulfilled’ state.
(7) Step 7: After successfully accessing the target cell, the UE transmits an indication of an available state of assistant information to the serving cell. The assistant information is associated with successful handover.
(8) Step 8: A target BS (e.g., a target gNB) transmits UE Information Request message to the UE after receiving the indication from the UE.
(9) Step 9: The UE transmits UE information response message to a target BS. Following information may be included in UE information response message:
   Time duration since “a leaving condition of an event (e.g., the 1st event or the 2nd event) is met” until “the CHO procedure is triggered”; and the corresponding event (e.g., the 1st event or the 2nd event).
   Time duration between “the 1st event is considered to be not fulfilled” and “the 2nd event is considered to be fulfilled”.
(10) Step 10: After the target BS receives the UE information response message from the UE, the target BS will transmit one Xn message (e.g., a failure indication message or a new Xn message) to the source BS.

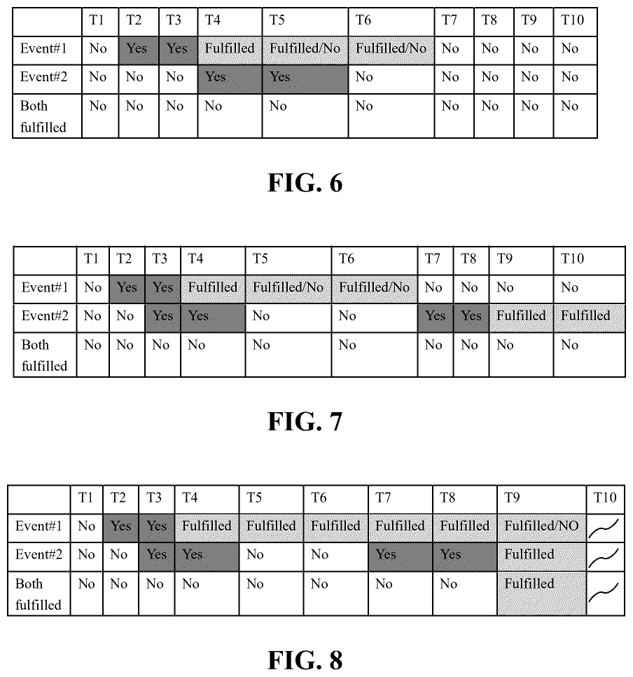

FIG. 6 illustrates an exemplary table of fulfillments of two events in a CHO procedure in accordance with some embodiments of the present application. The embodiments of FIG. 6 refer to a specific example of Embodiment 1.

The embodiments of FIG. 6 assume that both TTT1 of Event #1 (e.g., Event A3) and TTT2 of Event #2 (e.g., Event A5) are 3 time units in time domain. For example, in the embodiments of FIG. 6, a time unit may be a symbol, a time slot, a subframe, a millisecond, or other possible time unit in time domain. For example, a symbol is defined in 3GPP standard document TS38.331. The first row of FIG. 6 shows 10 time units in time domain, i.e., T1 to T10, for illustrative purpose. Although a specific number of time units are depicted in FIG. 6, it is contemplated that any number of time units may be included in the embodiments of FIG. 6.

In the embodiments of FIG. 6, a UE will evaluate whether Event #1 or Event #2 is fulfilled in each time unit from T1 to T10 in chronological order. The second row of FIG. 6 shows a fulfillment result of Event #1 in each time unit from T1 to T10. The third row of FIG. 6 shows a fulfillment result of Event #2 in each time unit from T1 to T10. The fourth row of FIG. 6 shows a fulfillment result of whether both Event #1 and Event #2 are fulfilled in each time unit from T1 to T10.

In particular, as shown in the second row of FIG. 6, “No” in T1 indicates that Event #1 is considered as in a ‘not fulfilled’ state in T1. “Yes” in T2 and T3 indicates that an entry condition of Event #1 is met in T2 and T3. Assuming that the entry condition of Event #1 is still met in T4, since TTT1 is assumed as 3 time units, TTT1 expires in T4 and hence Event #1 is considered to be ‘fulfilled’ for the first time as show in T4. “Fulfilled” in T5 and T6 indicates that Event #1 is considered as in a ‘fulfilled’ state in T5 and T6. “No” in T5 and T6 indicates that a leaving condition of Event #1 is met in T5 and T6. Assuming that the leaving condition of Event #1 is still met in T7, since TTT1 is assumed as 3 time units, TTT1 does not expire in T5 and T6 and hence Event #1 is considered in the ‘fulfilled’ state as show in T5 and T6; and TTT1 expires in T7 and hence Event #1 is considered to be ‘not fulfilled’ for the first time, i.e., “No” as show in T7. “No” in T8, T9, and T10 indicates that Event #1 is considered as in the ‘not fulfilled’ state in T8 to T10. That is, Event #1 is considered by the UE to be ‘fulfilled’ in T4; and after a period of the ‘fulfilled’ state from T4 to T6, Event #1 is considered to be ‘not fulfilled’ in T7 and Event #1 is considered as in the ‘not fulfilled’ state in T8 to T10.

As shown in the third row of FIG. 6, “No” in T1, T2, and T3 indicates that Event #2 is considered to be ‘not fulfilled’ in T1, T2, and T3, while “Yes” in T4 and T5 indicates that an entry condition of Event #2 is met in T4 and T5. Assuming that the entry condition of Event #2 is not met in T6, since TTT2 is assumed as 3 time units, TTT2 does not expire in T6 and hence Event #2 is considered to be ‘not fulfilled’, i.e., “No” as show in T6. “No” in T7, T8, T9, and T10 indicates that Event #2 is considered to be ‘not fulfilled’ in T7 to T10. That is, Event #2 is not considered by the UE to be ‘fulfilled’ in any time unit of T1 to T10.

As shown in the fourth row of FIG. 6, there is no time unit that both Event #1 and Event #2 are considered as in a ‘fulfilled’ state simultaneously. In this case, a UE may report following information:
(1) The UE reports measurement result(s) when one event is considered to be ‘fulfilled’ or ‘not fulfilled’.
   a) A measurement result(s) of the corresponding serving cell and the candidate cell associated with Event #2 when Event #1 is considered to be ‘fulfilled’ once, i.e., in time unit T4.
   b) A measurement result of the corresponding serving cell and candidate cell associated with Event #2 when Event #1 is considered to be ‘not fulfilled’ once, i.e., in time unit T7.
(2) The UE indicates which event is considered to be ‘fulfilled’. For example, the UE reports that Event #1 is considered as in a ‘fulfilled’ state in time units T4, T5, and T6, and/or reports the corresponding parameter(s) of Event #1, e.g., ofn, ocn, and/or TTT1.
(3) The UE reports a status for Event #2 when Event #1 is considered as in a ‘fulfilled’ state in time units T4, T5, and T6. The status of Event #2 could be as follows:
   a) The entry condition of Event #2 is ‘met’ when Event #1 is considered to be ‘fulfilled’ in time unit T4.
   b) The entry condition of Event #2 is ‘not met’ when Event #1 is considered to be ‘fulfilled’. The embodiments of FIG. 6 do not refer to this status of Event #2.
   c) The entry condition of Event #2 is ‘met’ when Event #1 is considered to be ‘not fulfilled’. The embodiments of FIG. 6 do not refer to this status of Event #2.
   d) The entry condition of Event #2 is ‘not met’ when Event #1 is considered to be ‘not fulfilled’ in time unit T7.
(4) The UE indicates a maximum period of meeting the entry condition of Event #2 while Event #1 is considered as in a ‘fulfilled’ state. As shown in FIG. 6, the maximum period is two time units from T4 to T5. This indication aims to optimize a value of TTT1 or TTT2. If TTT1 or TTT2 is too long, it is difficult to trigger a CHO procedure.
(5) The UE may report related time information, to optimize combined condition configuration of event(s) in a CHO procedure.
   a) Time duration between “Event #1 is considered to be fulfilled” and “Event #1 is considered to be not fulfilled”. As shown in FIG. 6, the time duration is three time units from T4 to T6. This time duration can assist a BS to optimize parameter(s) of Event #1. If the time duration is too short, the parameter(s) should be adjusted to configure longer time duration.
   b) The absolute time when Event #1 is considered to be ‘fulfilled’, e.g., UTC time of T4.
   c) The absolute time when Event #1 is considered to be ‘not fulfilled’, e.g., UTC time of T7.

FIG. 7 illustrates a further exemplary table of fulfillments of two events in a CHO procedure in accordance with some embodiments of the present application. The embodiments of FIG. 7 refer to a specific example of Embodiment 2.

The same as the embodiments of FIG. 6, the embodiments of FIG. 7 assume that both TTT1 of Event #1 (e.g., Event A3) and TTT2 of Event #2 (e.g., Event A5) are 3 time units in time domain. The first row of FIG. 7 shows 10 time units in time domain, i.e., T1 to T10. In the embodiments of FIG. 7, a UE will evaluate whether Event #1 or Event #2 is fulfilled in each time unit from T1 to T10 in chronological order. The second row of FIG. 7 shows a fulfillment result of Event #1 in each time unit from T1 to T10, which is the same as the second row of FIG. 6. The third row of FIG. 7 shows a fulfillment result of Event #2 in each time unit from T1 to T10, which is different from the second row of FIG. 6. The fourth row of FIG. 7 shows a fulfillment result of whether Event #1 and Event #2 are both fulfilled in each time unit from T1 to T10.

In particular, as shown in the third row of FIG. 7, “No” in T1 and T2 indicates that Event #2 is considered in a ‘not fulfilled’ state in T1 and T2, while “Yes” in T3 and T4 indicates that an entry condition of Event #2 is met in T3 and T4. Assuming that the entry condition of Event #2 is not met in T5, since TTT2 is assumed as 3 time units, TTT2 does not expire in T5 and hence Event #2 is considered in the ‘not fulfilled’ state, i.e., “No” as show in T5. “No” in T6 indicates that Event #2 is considered in the ‘not fulfilled’ state in T6. “Yes” in T7 and T8 indicates that the entry condition of Event #2 is met in T7 and T8. Assuming that the entry condition of Event #2 is still met in T9, since TTT2 is assumed as 3 time units, TTT2 expires in T9 and hence Event #2 is considered to be ‘fulfilled’ as show in T9. Event #2 is considered in a ‘fulfilled’ state as show in T10.

As shown in the fourth row of FIG. 7, there is no time unit that both Event #1 and Event #2 are considered as in a ‘fulfilled’ state simultaneously. In this case, Event #1 is considered to be fulfilled in T4, and then, Event #1 is considered to be ‘not fulfilled’ in T7. Event #2 is considered by the UE to be fulfilled in T9 after Event #1 is considered to be ‘not fulfilled’ in T7. In such case, the UE may report following information:
(1) The UE reports measurement result(s) when one event is considered to be ‘fulfilled’ or ‘not fulfilled’.
   a) A measurement result(s) of the corresponding serving cell and the candidate cell associated with Event #2 when Event #1 is considered to be ‘fulfilled’, i.e., in T4.
   b) A measurement result of the corresponding serving cell and candidate cell associated with Event #2 when Event #1 is considered to be ‘not fulfilled’, i.e., in T7.
   c) A measurement result of the corresponding serving cell and candidate cell associated with Event #1 when Event #2 is considered to be ‘fulfilled’, i.e., in T9.
   d) A measurement result of the corresponding serving cell and candidate cell associated with Event #1 when Event #2 is considered to be ‘not fulfilled’. The embodiments of FIG. 7 do not refer to this case.
(2) The UE indicates which event is considered to be ‘fulfilled’. For example, the UE reports that Event #1 is considered as in a ‘fulfilled’ state in T4, T5, and T6, and/or reports the corresponding parameter(s) of Event #1, e.g., TTT1.
(3) The UE reports a status for Event #2 when Event #1 is considered as in a ‘fulfilled’ state in T4, T5, and T6. The status of Event #2 could be as follows:
   a) The entry condition of Event #2 is ‘met’ when Event #1 is considered to be ‘fulfilled’ in T4.
   b) The entry condition of Event #2 is ‘not met’ when Event #1 is considered to be ‘fulfilled’. The embodiments of FIG. 7 do not refer to this status of Event #2.
(4) The UE indicates a maximum period of meeting the entry condition of Event #2 while Event #1 is considered to be ‘fulfilled’, i.e., one time unit of T4 as shown in FIG. 6. This indication aims to optimize a value of TTT1 or TTT2. If TTT1 or TTT2 is too long, it is difficult to trigger a CHO procedure.
(5) The UE indicates a maximum period of meeting the entry condition of Event #1 while Event #2 is considered to be ‘fulfilled’. The embodiments of FIG. 7 do not refer to this status of Event #2.
(6) The UE may report time information, to optimize combined condition configuration of event(s) in a CHO procedure.
   a) Time duration between “Event #1 is considered to be fulfilled” and “Event #1 is considered to be not fulfilled”, i.e., three time units including T4 to T6 as shown in FIG. 7. This time duration can assist a BS to optimize parameter(s) of Event #1. If the time duration is too short, the parameter(s) should be adjusted to configure longer time duration.
   b) Absolute time when Event #1 is considered to be ‘fulfilled’, i.e., absolute time of T4 (e.g., UTC time of T4).
   c) Absolute time when Event #1 is considered to be ‘not fulfilled’, i.e., absolute time of T7 (e.g., UTC time of T7).
   d) Absolute time when Event #2 is considered to be ‘fulfilled’, i.e., absolute time of T9 (e.g., UTC time of T9).
   e) Absolute time when Event #2 is considered to be ‘not fulfilled’, e.g., UTC time. The embodiments of FIG. 7 do not refer to this case.
   f) Time duration between “Event #1 is considered to be fulfilled” and “Event #2 is considered to be fulfilled”.
      As shown in FIG. 7, the time duration is from T4 to T9. The UE may report different number of time units for the time duration according to different implementations. In an example, the UE reports six time units (i.e., a total number of time units from T4 to T9) as the time duration. In another example, the UE reports five time units (i.e., T9-T4) as the time duration.
   g) Time duration between “Event #1 is considered to be not fulfilled” and “Event #2 is considered to be fulfilled”. As shown in FIG. 7, the time duration is three time units from T7 to T9.

FIG. 8 illustrates another exemplary table of fulfillments of two events in a CHO procedure in accordance with some embodiments of the present application. The embodiments of FIG. 8 refer to a specific example of Embodiment 3.

The same as the embodiments of FIG. 6, the embodiments of FIG. 8 assume that both TTT1 of Event #1 (e.g., Event A3) and TTT2 of Event #2 (e.g., Event A5) are 3 time units in time domain. The first row of FIG. 8 shows 10 time units in time domain, i.e., T1 to T10. In the embodiments of FIG. 8, a UE will evaluate whether Event #1 or Event #2 is fulfilled in each time unit from T1 to T10 in chronological order. Similar to the embodiments of FIG. 6, the second row of FIG. 8 shows a fulfillment result of Event #1 in each time unit from T1 to T10. The third row of FIG. 8 shows a fulfillment result of Event #2 in each time unit from T1 to T10. The fourth row of FIG. 8 shows a fulfillment result of whether Event #1 and Event #2 are both fulfilled in each time unit from T1 to T10.

In particular, as shown in the second row of FIG. 8, “No” in T1 indicates that Event #1 is considered in a ‘not fulfilled’ state in T1, while “Yes” in T2 and T3 indicates that an entry condition of Event #1 is met in T2 and T3. Assuming that the entry condition of Event #1 is still met in T4, since TTT1 is assumed as 3 time units, TTT1 expires in T4 and hence Event #1 is considered to be ‘fulfilled’ for the first time as show in T4. “Fulfilled” in T5 to T9 indicates that Event #1 is considered as in a ‘fulfilled’ state from T5 to T9. “No” in T9 indicates that a leaving condition of Event #1 is met in T9.

As shown in the third row of FIG. 8, “No” in T1 and T2 indicates that Event #2 is considered in a ‘not fulfilled’ state in T1 and T2, while “Yes” in T3 and T4 indicates that an entry condition of Event #2 is met in T3 and T4. Assuming that the entry condition of Event #2 is not met in T5, since TTT2 is assumed as 3 time units, TTT2 does not expire in T5 and hence Event #2 is considered in the ‘not fulfilled’ state, i.e., “No” as show in T5. “No” in T6 indicates that Event #2 is considered in the ‘not fulfilled’ state in T6. “Yes” in T7 and T8 indicates that the entry condition of Event #2 is met in T7 and T8. Assuming that the entry condition of Event #2 is still met in T9, since TTT2 is assumed as 3 time units, TTT2 expires in T9 and hence Event #2 is considered to be ‘fulfilled’ as show in T9.

As shown in the fourth row of FIG. 8, in time unit T9, both Event #1 and Event #2 are considered as in a ‘fulfilled’ state simultaneously. Thus, the UE may trigger to perform a CHO procedure in T9. Then, the UE will not evaluate whether Event #1 or Event #2 is fulfilled in time unit T10.

In this case, a CHO procedure with combined condition is triggered, but some ‘dangerous’ situation, e.g., a leaving condition of Event #1 is met when the CHO procedure is triggered, and thus, there is a need to optimize the unsuitable combined condition in the successful CHO procedure. In this case, in the embodiments of FIG. 8, the UE may transmit a SHR for a successful HO procedure. For instance, the following condition can be used to trigger the SHR:
(1) Trigger condition #1: a leaving condition of one event (e.g., Event #1 or Event #2) is met when the CHO procedure is triggered.
(2) Trigger condition #2: a time duration between “Event #1 is considered to be fulfilled for the first time” and “Event #2 is considered to be fulfilled for the first time” is greater than or equal to one configured threshold.
   a) As shown in FIG. 8, Event #1 is considered to be fulfilled for the first time in T4, and Event #2 is considered to be fulfilled for the first time in T9. Thus, the time duration is from T4 to T9 as shown in FIG. 8.
   b) The UE may compute the time duration as different number of time units according to different implementations. In an example, the UE computes six time units (i.e., a total number of time units from T4 to T9) as the time duration. If the configured threshold is four time units, Trigger condition #2 is met and thus the UE may transmit a SHR based on Trigger condition #2. In another example, the UE computes five time units (i.e., T9-T4) as the time duration. If the configured threshold is four time units, Trigger condition #2 is met and thus the UE may transmit a SHR based on Trigger condition #2.

For instance, the UE may include following information in the SHR:
(1) Time duration that a leaving condition of one event (e.g., Event #1) is met until the CHO procedure is triggered.
   a) As shown in FIG. 8, the leaving condition of Event #1 is met in T9, while both of Event #1 and Event #2 are considered as in the ‘fulfilled’ state in T9.Thus, the time duration is one time unit T9. The UE may report one time unit in the SHR.
   b) In another case, the leaving condition of Event #1 may be met in both T8 and T9 (not shown in FIG. 8), while Event #1 is considered as in the ‘fulfilled’ state in both T8 and T9, and both of Event #1 and Event #2 are considered as in the ‘fulfilled’ state in T9. In this case, the UE will trigger the CHO procedure in T9. Thus, the time duration is two time units, i.e., T8 and T9. The UE may report two time units in the SHR.
(2) Time duration between “Event #1 is considered to be fulfilled for the first time” and “Event #2 is considered to be fulfilled for the first time”.
   a) As shown in FIG. 8, Event #1 is considered to be fulfilled for the first time in T4, and Event #2 is considered to be fulfilled for the first time in T9. Thus, the time duration is from T4 to T9 as shown in FIG. 8. The UE may report different number of time units for the time duration according to different implementations. In an example, the UE reports six time units (i.e., a total number of time units from T4 to T9) as the time duration in the SHR. In another example, the UE reports five time units (i.e., T9-T4) as the time duration in the SHR.

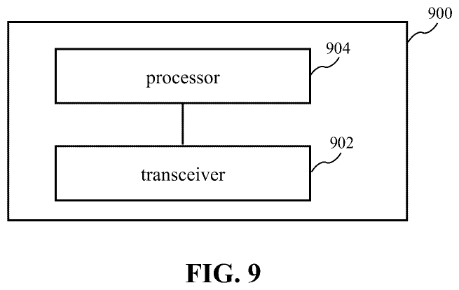

FIG. 9 illustrates an exemplary block diagram of an apparatus in accordance with some embodiments of the present application. As shown in FIG. 9, the apparatus 900 may include at least one processor 904 and at least one transceiver 902 coupled to the processor 904. The apparatus 900 may be a UE or a network node (e.g., a BS).

Although in this figure, elements such as the at least one transceiver 902 and processor 904 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The transceiver 902 in the UE may be configured: to receive, via the wireless transceiver from a network node, CHO configuration information associated with a candidate cell of the UE, wherein the CHO configuration information includes an execution condition comprising an event and a further event; and to transmit, via the wireless transceiver to the network node, assistant information related to at least one of the event and the further event.

In some embodiments of the present application, the apparatus 900 may further include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 904 interacting with transceiver 902, so as to perform operations of the methods, e.g., as described in view of any of FIGS. 5-8.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1.-15. (canceled)

16. A user equipment (UE), comprising:
at least one memory; and
at least one processor coupled with the at least one memory and configured to cause the UE to:
receive, from a network node, conditional handover (CHO) configuration information associated with a candidate cell of the UE, wherein the CHO configuration information includes an execution condition comprising a first event and a second event; and
transmit, to the network node, assistant information related to at least one of the first event and the second event.

17. The UE of claim 16, wherein the processor is further configured to cause the UE to:
in response to a presence of a radio link failure (RLF) or a handover failure, perform a radio resource control (RRC) re-establishment procedure to a cell.

18. The UE of claim 17, wherein the processor is further configured to cause the UE to:
transmit, to the re-established cell, an indication of an available state of the assistant information;
receive a UE information request message from the re-established cell; and
transmit, to the re-established cell, a UE information response message including the assistant information.

19. The UE of claim 17, wherein the assistant information includes at least one of:
a measurement result of a serving cell of the UE if the first event is considered by the UE to be fulfilled;
a measurement result of the candidate cell if the first event is considered by the UE to be fulfilled;
the measurement result of the serving cell if the second event is considered by the UE to be fulfilled; and
the measurement result of the candidate cell if the second event is considered by the UE to be fulfilled.

20. The UE of claim 17, wherein the assistant information includes at least one of:
a measurement result of a serving cell of the UE if the first event is considered by the UE to be not fulfilled;
a measurement result of the candidate cell if the first event is considered by the UE to be not fulfilled;
the measurement result of the serving cell if the second event is considered by the UE to be not fulfilled; and
the measurement result of the candidate cell if the second event is considered by the UE to be not fulfilled.

21. The UE of claim 16, wherein the processor is further configured to cause the UE to:
in response to the first event considered by the UE to be fulfilled, transmit, to the network node, information indicating that the first event is in a fulfilled state; and
transmit, to the network node, information associated with the first event,
wherein the information associated with the first event includes at least one of:
information regarding a timer to trigger (TTT);
a measurement object specific offset of a reference signal of a neighbor cell of the UE;
a cell specific offset of the neighbor cell;
a measurement object specific offset of a primary cell of a master or secondary cell group (SpCell) of the UE;
a cell specific offset of the SpCell; and
an offset parameter for the first event.

22. The UE of claim 16, wherein the assistant information includes at least one of:
an entry condition of the second event is met if the first event is considered by the UE to be fulfilled; and
the entry condition of the second event is not met if the first event is considered by the UE to be fulfilled.

23. The UE of claim 16, wherein the assistant information includes at least one of:
a maximum time period of meeting an entry condition of the second event while the first event is in a fulfilled state; and
a maximum time period of meeting an entry condition of the first event while the second event is in the fulfilled state.

24. The UE of claim 16, wherein the assistant information includes at least one of:
absolute time when the first event is considered by the UE to be fulfilled;
absolute time when the first event is considered by the UE to be not fulfilled;
absolute time when the second event is considered by the UE to be fulfilled; and
absolute time when the second event is considered by the UE to be not fulfilled.

25. The UE of claim 16, wherein the assistant information includes at least one of:
a time duration since the first event considered to be fulfilled until the first event considered to be not fulfilled;
a time duration since the first event considered to be fulfilled until the second event considered to be fulfilled; and
a time duration since the first event considered to be not fulfilled until the second event considered to be fulfilled.

26. The UE of claim 16, wherein the processor is further configured to cause the UE to:
perform a CHO procedure in response to meeting the execution condition; and
transmit a successful handover report (SHR) in response to meeting a trigger condition.

27. The UE of claim 26, wherein the trigger condition is at least one of:
a leaving condition of the first event is met when the UE triggers to perform the CHO procedure; and
a leaving condition of the second event is met when the UE triggers to perform the CHO procedure.

28. The UE of claim 26, wherein the trigger condition is at least one of:
a time duration since the first event considered to be fulfilled until the second event considered to be fulfilled is greater than or equal to a first threshold; and
a time duration since the second event considered to be fulfilled until the first event considered to be fulfilled is greater than or equal to a second threshold.

29. The UE of claim 26, wherein the SHR includes at least one of:
a time duration of consecutively meeting a leaving condition of the first event when the UE performs the CHO procedure;
a time duration of consecutively meeting a leaving condition of the second event when the UE performs the CHO procedure;
a time duration since the first event considered to be fulfilled until the second event considered to be fulfilled;
a time duration since the first event is considered to be fulfilled until the first event is considered to be not fulfilled;
absolute time when the first event is considered to be fulfilled;
absolute time when the first event is considered to be not fulfilled;
absolute time when the second event is considered to be fulfilled;
absolute time when the second event is considered to be not fulfilled; and
a time duration since the first event is considered to be not fulfilled until the second event is considered to be fulfilled.

30. A processor for wireless communication, comprising:
at least one controller coupled with at least one memory and configured to cause the processor to:
receive, from a network node, conditional handover (CHO) configuration information associated with a candidate cell of the processor, wherein the CHO configuration information includes an execution condition comprising a first event and a second event; and
transmit, to the network node, assistant information related to at least one of the first event and the second event.

31. The processor of claim 30, wherein the controller is further configured to cause the processor to:
in response to a presence of a radio link failure (RLF) or a handover failure, perform a radio resource control (RRC) re-establishment procedure to a cell.

32. The processor of claim 30, wherein the controller is further configured to cause the processor to:
perform a CHO procedure in response to meeting the execution condition; and
transmit a successful handover report (SHR) in response to meeting a trigger condition.

33. A method performed by a User Equipment (UE), the method comprising:
receiving, from a network node, conditional handover (CHO) configuration information associated with a candidate cell of the UE, wherein the CHO configuration information includes an execution condition comprising a first event and a second event; and
transmit, to the network node, assistant information related to at least one of the first event and the second event.

34. The method of claim 33, further comprising:
in response to a presence of a radio link failure (RLF) or a handover failure, performing a radio resource control (RRC) re-establishment procedure to a cell.

35. The method of claim 33, further comprising:
performing a CHO procedure in response to meeting the execution condition; and
transmitting a successful handover report (SHR) in response to meeting a trigger condition.
